(19) United States
(12) Patent Application Publication
(10) Pub. No.: US 2026/0094754 A1
(43) Pub. Date: Apr. 2, 2026

(54) INDUCTIVE DEVICE AND POWER CONVERTER USING THE SAME

(71) Applicant: LITE-ON TECHNOLOGY CORPORATION, TAIPEI CITY (TW)

(72) Inventors: Cheng-Wei TSENG, TAIPEI CITY (TW); Han-Min HUANG, TAIPEI CITY (TW); Chen CHEN, TAIPEI CITY (TW); Dung Ruen HO, TAIPEI CITY (TW); YAO CHENG TIEN, TAIPEI CITY (TW); Kai-De CHEN, Taipei City (TW)

(21) Appl. No.: 19/318,595

(22) Filed: Sep. 4, 2025

Related U.S. Application Data
(60) Provisional application No. 63/699,973, filed on Sep. 27, 2024.

(30) Foreign Application Priority Data
Jun. 4, 2025 (CN) 202510736782.3

(51) Int. Cl. H01F 27/00; H01F 27/26; H01F 27/28; H01F 27/34

(52) U.S. Cl. CPC H01F 27/006; H01F 27/266; H01F 27/2804; H01F 27/34; H01F 2027/2809

(57) ABSTRACT

An inductive device includes a support member, a magnetic core, and a plurality of branches. The magnetic core is arranged in the support member. The branches are arranged in the support member and are connected in parallel with each other. Each branch has a winding structure and surrounds the magnetic core. All windings that are arranged on different branches are arranged in an interleaved manner.

### CROSS REFERENCE TO RELATED APPLICATIONS

This application claims the benefit of U.S. provisional application No. 63/699,973, filed Sep. 27, 2024, and priority of China patent application No. 202510736782.3, filed Jun. 4, 2025, the entirety of which is incorporated by reference herein.

### TECHNICAL FIELD

The present invention relates to an electronic component, and more particularly to an inductive device used in power conversion equipment.

### BACKGROUND

The inductive device is a component that operates based on the principle of electromagnetic induction, such as an inductor. The inductive device stores energy in a magnetic field and plays a critical role in many electronic and power systems. In power supply and filtering applications, particularly in DC-DC converters (e.g., Buck and Boost converters), these inductive devices are responsible for energy storage and voltage conversion, as well as filtering out high-frequency noise in the voltage, thereby ensuring stable circuit operation.

In general, the basic structure of an inductive device, taking an inductor as an example, includes a winding and a magnetic core. The winding is primarily in the form of a coil, which generates a magnetic field when current flows through it. The magnetic core serves as the main magnetic path, confining the magnetic flux within itself to concentrate and enhance the magnetic field, thereby increasing the inductance. There are many types of magnetic cores, such as toroid, E-shaped, U-shaped, rod-shaped, and cylindrical, which vary depending on the specific application.

As the growing demand for miniaturization of power converters, the available space for electronic products has become increasingly limited. Although traditional inductors can achieve relatively high inductance within a limited volume or size, they still require dedicated space on the surface of the printed circuit board (PCB) for the placement and fixation of the magnetic core. As a result, they occupy a portion of the usable design space of the product.

### BRIEF SUMMARY

Accordingly, the present invention provides an inductive device in which the magnetic core is integrated into a support member, thereby avoiding the occupation of the surface area of the printed circuit board (PCB). In addition, by employing a specific configuration of branches, windings, and board layer arrangements, the inductive device enhances inductance and reduces conductor losses.

An embodiment of the present invention provides an inductive device, includes a support member, a magnetic core, and a plurality of branches. The magnetic core is arranged in the support member. The branches that are arranged in the support member are connected in parallel with each other. Each branch has a winding structure, and is wound around the magnetic core.

In some aspects of the above-mentioned embodiment, the support member includes a plurality of board layers, each of which is provided with a winding. Furthermore, the winding structure of each branch is formed by a predetermined number of windings connected in series. The predetermined number of windings are disposed on different board layers.

In some aspects of the above-mentioned embodiment, the branches include a first branch to an n-th branch. Among the first branch to the n-th branch, all the windings disposed on different branches are arranged in an interleaved manner.

In some aspects of the above-mentioned embodiment, n is at least 2, and the predetermined number is at least 2.

In some aspects of the above-mentioned embodiment, the branches include a first branch to an n-th branch. The windings that form the winding structures of the first to the n-th branches are arranged in a symmetrical manner.

In some aspects of the above-mentioned embodiment, each of the first branch to the n-th branch includes at least one winding and another winding connected in series. Furthermore, the symmetrical arrangement of the windings includes an arrangement from one winding of the first branch to one winding of the n-th branch, and from said winding of the n-th branch to another winding of the first branch.

In some aspects of the above-mentioned embodiment, the product of the predetermined number multiplied by the number of branches is not greater than the number of board layers.

In some aspects of the above-mentioned embodiment, the surface layer of the support member covers the magnetic core.

In some aspects of the above-mentioned embodiment, the support member is a multilayer printed circuit board.

In some aspects of the above-mentioned embodiment, each winding disposed on the respective board layer is made of a conductor.

In some aspects of the above-mentioned embodiment, the conductor is copper.

In some aspects of the above-mentioned embodiment, a portion of the magnetic core surrounded by windings is a continuous integrated (monolithic) structure.

In some aspects of the above-mentioned embodiment, the magnetic core is embedded within the support member.

Another embodiment of the present invention provides a power converter. The power converter includes a switching module and the above-mentioned inductive device. The inductive device is coupled to the switching module.

### BRIEF DESCRIPTION OF THE DRAWINGS

The present disclosure can be more fully understood by reading the subsequent detailed description and examples with references made to the accompanying drawings, wherein:

FIG. 1 illustrates schematic diagrams of the winding structures of two inductors.

FIG. 2 illustrates a schematic diagram of the structure of the inductive device according to the present invention.

FIG. 3 illustrates the configuration relationship between the branches and board layers of the inductive device as shown in FIG. 2.

FIG. 4 illustrates a schematic diagram of the structure of the inductive device according to another embodiment of the present invention.

### DETAILED DESCRIPTION

The following description is made for the purpose of illustrating the general principles of the disclosure and should not be taken in a limiting sense. The scope of the disclosure is best determined by reference to the appended claims.

To make the above-mentioned objects, features, and advantages of the present invention more clearly understood, preferred embodiments described in detail below with reference to the accompanying drawings.

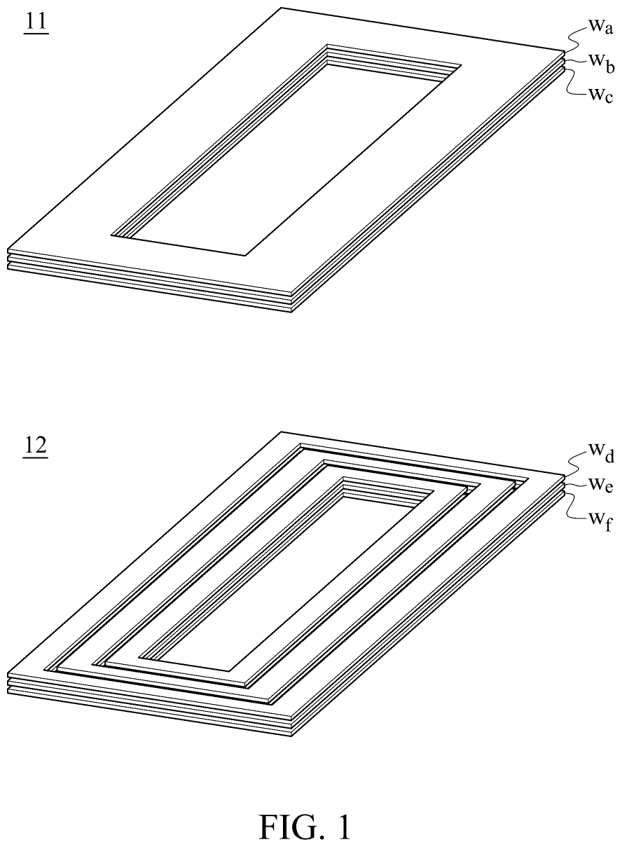

FIG. 1 shows schematic diagrams of the winding structures of two inductors. In FIG. 1, the winding 11 has a three-layer structure, with coils wₐ, w_{b}, and w_{c} respectively arranged on the first, second, and third layers. The winding 12 also has a three-layer structure, with coils w_{d}, wₑ, and w_{f} respectively arranged on the first, second, and third layers. It should be noted that each of the coils wₐ, w_{b}, and w_{c} has one turn, and they are connected in series. In addition, each of the coils w_{d}, wₑ, and w_{f} has three turns, and they are connected in parallel. The equivalent number of turns for both winding 11 and winding 12 is three.

Under the same footprint area, for example 160 mm², the inductance and copper loss of the winding 11 and the winding 12 are compared. The results are shown in Table 1.

TABLE 1

| | |
|---|---|
| Winding 11 | Winding 12 |

| | | | | |
|---|---|---|---|---|
| Inductance | 152 | nH | 133 | nH |
| Copper Loss | 4.13 | W | 4.58 | W |

As shown in Table 1, the winding 11 (one turn per layer, three coils (layers) connected in series) achieves a higher inductance compared to the winding 12 (three turns per layer, three coils (layers) connected in parallel) under the same unit of copper loss (conductor loss).

According to Equation [1], when two inductors (or windings) L₁ and L₂ (each having an inductance value assumed to be L) are connected in parallel and are perfectly coupled (i.e., the mutual inductance M between the inductors L₁ and L₂ is equal to L), the ideal equivalent inductance L_{eq} of the parallel connection of L₁ and L₂ will remain as L.

$${L}_{eq} = \frac{{L}_{1} {L}_{2} - {M}^{2}}{{L}_{1} + {L}_{2} - 2 M} = \frac{L + M}{2} = L \qquad [ 1 ]$$

However, in practice, inductors (or windings) placed on different layers are not perfectly coupled. As the number of parallel layers increases, the overall inductance tends to decrease, making it more difficult to achieve the target inductance value.

The inductive device (inductor) proposed in the present invention incorporates a high magnetic permeability material (magnetic core) into the support member that includes windings formed therein, in order to increase inductance. The support member may be, for example, a printed circuit board (PCB), which includes multiple layers, with windings (conductor coils) formed on each layer. Moreover, the high-permeability material may be, for example, a ferrite magnetic core. In the embodiment of the present invention, the magnetic core is integrated into the PCB, and the inductive device having this structure is referred to as a heterogeneous integrated inductive device (inductor).

In the heterogeneous integrated inductor of the present invention, assuming that three windings are respectively formed on the first to third board layers, thus the series equivalent inductance of the inductor is as shown in Equation [2].

$${L}_{eq} = {L}_{1} + {L}_{2} + {L}_{3} + 2 \times ( {L}_{12} + {L}_{23} + {L}_{13} ) \qquad [ 2 ]$$

The self-inductances of the windings on the first to third substrate layers are denoted as L₁ to L₃, respectively. The mutual inductances between the windings on the first and second layers, the second and third layers, and the first and third layers are denoted as L₁₂, L₂₃, and L₁₃, respectively. As shown in Equation [2], by enhancing the coupling between the board layers (windings), the overall series inductance can be significantly increased. Here, a three-layer (three-winding) example is used for explanation; as the number of board layers increases, the mutual inductances between the board layers (windings) will also increase significantly.

In addition, taking a heterogeneous integrated inductor with 20 windings respectively formed on 20 board layers as an example, the performance results of the inductor without an integrated magnetic core and with an integrated magnetic core on a printed circuit board (PCB) are shown in Table 2.

TABLE 2

| PCB with core? | Copper Loss (W) | Inductance (nH) |
|---|---|---|
| No | 2.26 | 151.00 |
| Yes | 2.65 | 229.00 |

In view of Table 2, the inclusion of a magnetic core results in a 17.3% increase in copper loss, however it also leads to a 51% increase in inductance. Therefore, the trade-off of a slight increase in copper loss for a significant enhancement in overall inductance is considered worthwhile.

The inductive device proposed in the present invention integrates the magnetic core within the printed circuit board (PCB), thereby avoiding the occupation of the PCB surface. In addition, by employing a specific configuration of branches and windings, as well as an optimized arrangement of board layers, the inductance is increased while the conductor loss (copper loss) is reduced. The following describes the configuration of branches and windings, as well as the board layer arrangement of the inductive device according to the present invention.

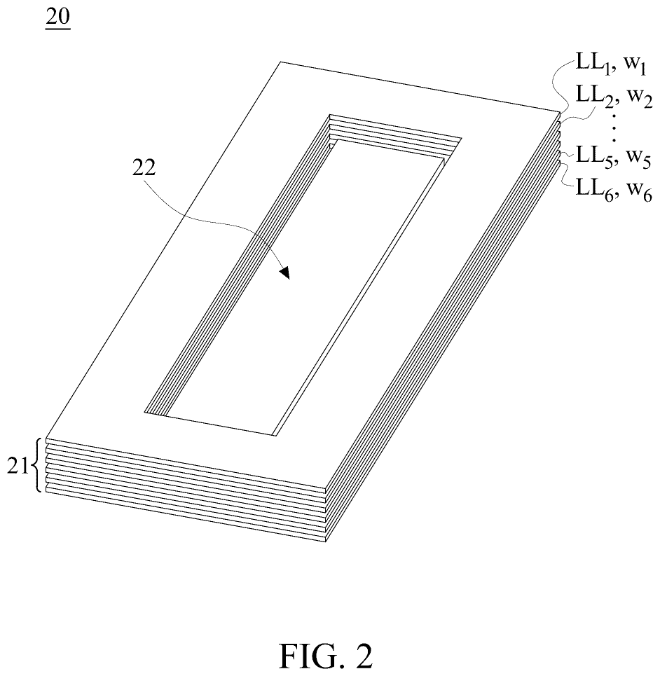

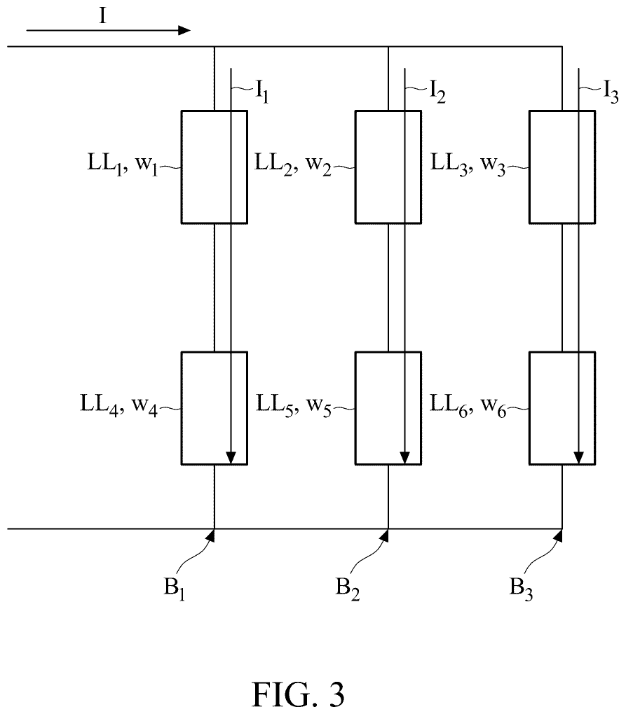

FIG. 2 illustrates a schematic diagram of the structure of the inductive device according to the present invention. The inductive device 20 includes a support member 21, a magnetic core 22, and n branches B₁, B₂, . . . to Bₙ (as shown in FIG. 3, where n=3, for example but not limited thereto). The magnetic core 22, for example, may be made of ferrite, and is embedded within the support member 21. The support member 21 may be, for instance, a printed circuit board (PCB). Among the multiple board layers of the PCB, at least k board layers LL₁ to LLₖ are provided, on which a total of k windings (w₁ to wₖ) are formed. In FIG. 2, the example of k=6 is illustrated, but this is not limited thereto. The support member 21 includes branches B₁ to Bₙ, which are connected in parallel with each other. It should be noted that each branch includes a winding structure ws₁ to wsₙ (not shown in FIG. 2 and FIG. 3); moreover, each winding structure is formed by a series connection of windings disposed on different board layers. The winding structures ws₁ to wsₙ of all branches B₁ to Bₙ surround the magnetic core 22.

Each winding structure (ws₁ to wsₙ) of the multiple branches (B₁ to Bₙ) is composed of a series connection of a predetermined number (p) of windings; and p×n=k.

Since k windings w₁ to wₖ are respectively formed on the k board layers LL₁ to LLₖ, for brevity in the following descriptions, the winding wₖ may at times be used to also refer to the corresponding board layer LLₖ, and vice versa, the board layer LLₖ may be used to refer to the corresponding winding wₖ.

In addition, the number of turns of the winding formed on each board layer may be equal to 1 or greater than 1. In the following descriptions, it is assumed that each winding formed on a board layer has only one turn; however, this is not limited thereto.

In addition, the magnetic core 22 may be embedded within the support member 21 without being exposed on the surface of the support member 21; in other words, the magnetic core 22 does not protrude from the surface layer of the printed circuit board. As a result, the surface area of the PCB is not occupied by the magnetic core and can therefore be utilized for mounting other electronic components.

The structure of the inductive device 20 shown in FIG. 2 has six windings (k=6) as an example; however, it is not limited to this configuration. As illustrated in FIG. 2, windings are provided on six board layers within the support member 21 (the printed circuit board). Furthermore, in FIG. 2, the notations “LL₁, w₁”, “LL₂, w₂”, “LL₃, w₃”, “LL₄, w₄”, “LL₅, w₅”, and “LL₆, w₆” are examples that simultaneously indicate both the board layers and the windings formed thereon.

FIG. 3 illustrates the configuration relationship between the branches and the board layers of the inductive device 20 shown in FIG. 2. The branches may also be referred to as parallel branches or current branches.

In the embodiment shown in FIG. 3, the inductive device 20 includes a first branch B₁, a second branch B₂, and a third branch B₃; that is, the case where n=3. In this embodiment, the predetermined number p of windings in each branch is 2; however, p may be greater than 2 in some embodiments. As illustrated in FIG. 3, the first branch B₁ includes a winding structure ws₁ composed of a series connection of the winding w₁ formed on the board layer LL₁ and the winding w₄ formed on the board layer LL₄. The second branch B₂ includes a winding structure ws₂ composed of a series connection of the winding w₂ on the board layer LL₂ and the winding w₅ on the board layer LL5. The third branch B₃ includes a winding structure ws₃ composed of a series connection of the winding w₃ on the board layer LL₃ and the winding w₆ on the board layer LL₆. The above-mentioned three winding structures ws₁ to ws₃ are connected in parallel with one another. When current I flows through the inductive device 20, branch currents I₁, I₂ and I₃ respectively flow through the first, second and third branches (B₁, B₂ and B₃).

Table 3 summarizes the winding configuration relationship between the branches (B₁, B₂, and B₃) and the board layers (LL₁, LL₂ and LL₃) as shown in FIG. 3. Such winding configuration relationship is also referred to as arrangement relationship or stacking relationship.

TABLE 3
Winding configuration of a PCB with six board layers

| | Arrangement of branches |
|---|---|
| Board layers of PCB (winding) | (each with a winding structure) |
| LL₁ (w₁) | B₁ |
| LL₂ (w₂) | B₂ |
| LL₃ (w₃) | B₃ |
| LL₄ (w₄) | B₁ |
| LL₅ (w₅) | B₂ |
| LL₆ (w₆) | B₃ |

In view of Table 3, the windings w₁ and w₄ in the first branch B₁, the windings w₂ and w₅ in the second branch B₂, and the windings w₃ and w₆ in the third branch B₃ are arranged in an interleaved stacking manner within the support member 21. This type of configuration is hereinafter referred to as an interleaved arrangement. For example, this interleaved arrangement is implemented by using via holes to respectively connect the winding w₁ on the board layer LL₁ in series with the winding w₄ on the board layer LL₄, the winding w₂ on the board layer LL₂ with the winding w₅ on layer LL₅, and the winding w₃ on the board layer LL₃ with the winding w₆ on layer LL₆, thereby forming the first to third branches B₁ to B₃.

Table 4 provides a summary of three different winding configurations of the inductive device and their corresponding copper losses. Note that the predetermined number p of windings in each branch is 2.

TABLE 4
Winding configuration in a PCB with six board layers

| Board layer | General | Interleaved | Symmetrical |
|---|---|---|---|
| (winding) | configuration | configuration | configuration |
| LL₁ (w₁) | B₁ | B₁ | B₁ |
| LL₂ (w₂) | B₁ | B₂ | B₂ |
| LL₃ (w₃) | B₂ | B₃ | B₃ |
| LL₄ (w₄) | B₂ | B₁ | B₂ |
| LL5 (w5) | B₃ | B₂ | B₁ |
| LL6 (w6) | B₃ | B₃ | B₃ |
| Cooper loss | 1.02 | 0.86 | 0.97 |
| (W) | | | |

The interleaved configuration in Table 4 corresponds to the arrangement shown in Table 3.

The general configuration in Table 4 is implemented by connecting the windings w₁ and w₂ on the board layers LL₁ and LL₂ in series, connecting the windings w₃ and w₄ on the board layers LL₃ and LL₄ in series, and connecting the windings w₅ and w₆ on the board layers LL₅ and LL₆ in series, through via holes respectively, thereby forming the first to third branches B₁ to B₃.

The symmetrical configuration in Table 4 is implemented by connecting the winding w₁ on the board layer LLU with the winding w₅ on the board layer LL₅ in series, the winding w₂ on the board layer LL₂ with the winding w₄ on the board layer LL₄, and the winding w₃ on the board layer LL₃ with the winding w₆ on the board layer LL₆, through via holes respectively, thereby forming the first to third branches B₁ to B₃. Since the arrangement of the windings w₁ to w₆ on the corresponding branches follows the order “B₁-B₂-B₃-B₂-B₁-B₃,” which partially exhibits a symmetrical sequence “1-2-3-2-1,” this configuration is referred to as a symmetrical arrangement.

It should be noted that, in view of Table 4, in terms of copper loss (power loss) of the inductive device, the interleaved configuration results in lower copper loss than the symmetrical configuration, and the symmetrical configuration has lower copper loss than the general configuration. This indicates that the inductive device with an interleaved arrangement exhibits lower copper loss.

Table 5 provides a summary of four different winding configurations of the inductive device when the PCB has 12 board layers, along with their corresponding copper losses. Note that there are three branches (B1 to B3), and the predetermined number p of windings in each branch is 4.

TABLE 5
Winding configuration of a PCB with 12 board layers

| | | Semi- | (Fully) | |
|---|---|---|---|---|
| Board layer | General | interleaved | Interleaved | Symmetrical |
| (winding) | configuration | configuration | configuration | configuration |
| LL₁ (w₁) | B₁ | B₁ | B₁ | B₁ |
| LL₂ (w₂) | B₁ | B₁ | B₂ | B₂ |
| LL₃ (w₃) | B₁ | B₂ | B₃ | B₃ |
| LL₄ (w₄) | B₁ | B₂ | B₁ | B₂ |
| LL₅ (w₅) | B₂ | B₃ | B₂ | B₁ |
| LL₆ (w₆) | B₂ | B₃ | B₃ | B₃ |
| LL₇ (w₇) | B₂ | B₁ | B₁ | B₁ |
| LL₈ (w₈) | B₂ | B₁ | B₂ | B₂ |
| LL₉ (w₉) | B₃ | B₂ | B₃ | B₃ |
| LL₁₀ (w₁₀) | B₃ | B₂ | B₁ | B₂ |
| LL₁₁ (w₁₁) | B₃ | B₃ | B₂ | B₁ |
| LL₁₂ (w₁₂) | B₃ | B₃ | B₃ | B₃ |
| Copper loss | 2.89 | 2.35 | 2.08 | 2.26 |
| (W) | | | | |

The “(fully) interleaved,” “general,” and “symmetrical” configurations in Table 5 are similar to the “interleaved,” “general,” and “symmetrical” configurations in Table 4, and are therefore not described in detail herein.

The semi-interleaved configuration in Table 5 is implemented by connecting the windings w₁ and w₂ on the board layers LL₁ and LL₂ in series with the windings w₇ and w₈ on the board layers LL₇ and LL₈; connecting the windings w₃ and w₄ on the board layers LL₃ and LL₄ in series with the windings w₉ and w₁₀ on the board LL₉ and LL₁₀; and connecting the windings w₅ and w₆ on the board layers LL₅ and LL₆ in series with the windings wₙ and w₁₂ on the board layers LL₁₁ and LL₁₂; respectively, through via holes. These three groups of winding connection form the first to third branches B₁ to B₃.

In view of Table 5, the inductive device with (fully) interleaved configuration still exhibits the lowest copper loss (2.08 W), followed by the one with the symmetrical configuration (2.26 W).

Table 6 provides a summary of four different winding configurations of the inductive device when the PCB has 18 board layers, along with their corresponding copper losses. Note that there are three branches (B₁ to B₃), and the predetermined number p of windings in each branch is 6.

TABLE 6
Winding configuration of a PCB with 18 board layers

| | | Semi- | (Fully) | |
|---|---|---|---|---|
| Board layer | General | interleaved | Interleaved | Symmetrical |
| (winding) | configuration | configuration | configuration | configuration |
| LL₁ (w₁) | B₁ | B₁ | B₁ | B₁ |
| LL₂ (w₂) | B₁ | B₁ | B₂ | B₂ |
| LL₃ (w₃) | B₁ | B₁ | B₃ | B₃ |
| LL₄ (w₄) | B₁ | B₂ | B₁ | B₂ |
| LL₅ (w₅) | B₁ | B₂ | B₂ | B₁ |
| LL₆ (w₆) | B₁ | B₂ | B₃ | B₃ |
| LL₇ (w₇) | B₂ | B₃ | B₁ | B₁ |
| LL₈ (w₈) | B₂ | B₃ | B₂ | B₂ |
| LL₉ (w₉) | B₂ | B₃ | B₃ | B₃ |
| LL₁₀ (w₁₀) | B₂ | B₁ | B₁ | B₂ |
| LL₁₁ (w₁₁) | B₂ | B₁ | B₂ | B₁ |
| LL₁₂ (w1₂) | B₂ | B₁ | B₃ | B₃ |
| LL₁₃ (w₁₃) | B₃ | B₂ | B₁ | B₁ |
| LL₁₄ (w₁₄) | B₃ | B₂ | B₂ | B₂ |
| LL₁₅ (w₁₅) | B₃ | B₂ | B₃ | B₃ |
| LL₁₆ (w₁₆) | B₃ | B₃ | B₁ | B₂ |
| LL₁₇ (w₁₇) | B₃ | B₃ | B₂ | B₁ |
| LL₁₈ (w₁₈) | B₃ | B₃ | B₃ | B₃ |
| Copper loss | 5.48 | 4.60 | 3.97 | 4.16 |
| (W) | | | | |

The general, semi-interleaved, (fully) interleaved, and symmetrical configurations in Table 6 are similar to those in Table 5 and are therefore not described in detail. In view of Table 6, the inductive device with (fully) interleaved configuration still exhibits the lowest copper loss (3.97 W), followed by the one with the symmetrical configuration (4.16 W).

In view of Table 4 to Table 6, it can be seen that the inductive device with interleaved configuration generally exhibits the lowest copper loss, while the symmetrical configuration typically results in the second-lowest copper loss. Accordingly, in the heterogeneous integrated inductive device of the present invention, the optimal choice is interleaved configuration, followed by the symmetrical configuration as the next best option.

In conventional structures of inductive devices, such as inductors using E-E type magnetic cores, the presence of an air gap design typically causes a noticeable decrease in the imaginary part of the impedance in windings located closer to the air gap (see Table 7), which may result in impedance discontinuity issues. In Table 7, since the air gap is approximately located between winding layers L₆ and L₇, the imaginary impedance near winding layers L₅, L₆, and L₇ is significantly lower.

TABLE 7
Conventional inductive device with E-E type magnetic core

| Winding layer | Imaginary impedance (mΩ) |
|---|---|
| L₁ | 122 |
| L₂ | 107 |
| L₃ | 91 |
| L₄ | 78 |
| L₅ | 69 |
| L₆ | 67 |
| L₇ | 68 |
| L₈ | 75 |
| L₉ | 88 |
| L₁₀ | 104 |
| L₁₁ | 119 |
| L₁₂ | 134 |

In the heterogeneous integrated inductor device according to the embodiment of the present invention, the portion of the magnetic core surrounded by the windings is formed as a continuous and integrated (or monolithic) structure, and thus does not incorporate air gap. As a result, the imaginary part of the impedance across the winding layers is more continuous. In addition, by applying an interleaved arrangement, the impedance of the branches composed of windings from different board layers becomes more uniform (after averaging), thereby improving current sharing and reducing power loss. As shown in Table 8, compared to conventional structures of inductive devices, the impedance variation across the winding layers is significantly smaller and more continuous.

TABLE 8
Heterogeneous integrated inductive Device
with integrated magnetic core

| Winding layer | Imaginary impedance (mΩ) |
|---|---|
| L₁ | 289 |
| L₂ | 295 |
| L₃ | 301 |
| L₄ | 307 |
| L₅ | 312 |
| L₆ | 315 |
| L₇ | 316 |
| L₈ | 314 |
| L₉ | 310 |
| L₁₀ | 305 |
| L₁₁ | 299 |
| L₁₂ | 293 |

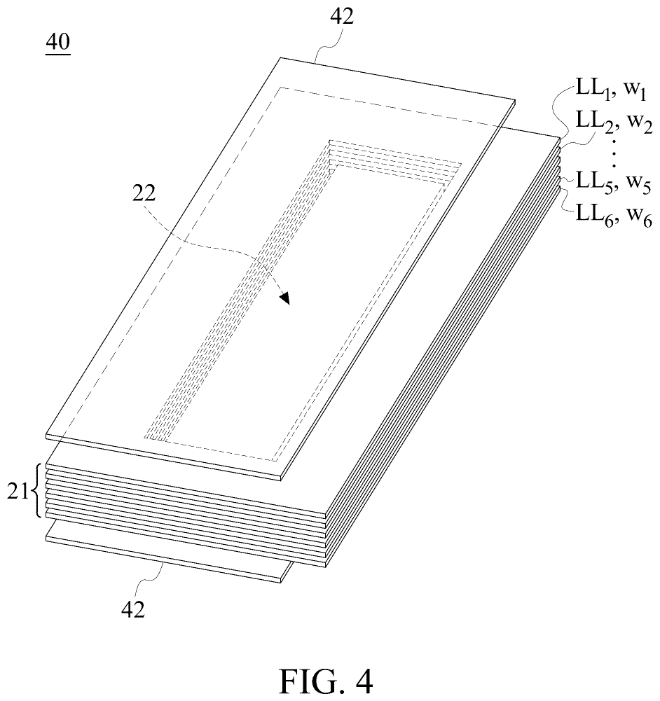

FIG. 4 illustrates a schematic diagram of the structure of the inductive device according to another embodiment of the present invention.

The structure of the inductive device 40 shown in FIG. 4 has the same structure of the inductive device 20 shown in FIG. 2, except that further including at least a high magnetic permeability layer 42. The same elements in FIG. 2 and FIG. 4 are indicated by the same symbols or notations.

The magnetic core 22 and the branches B₁˜B₃ (not shown in FIG. 4, which include the windings w₁˜w₆) are covered by the high magnetic permeability layer 42. It should be noted that the magnetic permeability of the high magnetic permeability layer is more than three times that of the magnetic core 22.

The high magnetic permeability layer 42 is provided on the surface of the support member 21 (i.e., the printed circuit board), without contacting the magnetic core 22 and the windings w₁˜w₆ (or the branches B₁˜B₃).

In addition, the high magnetic permeability layer 42 completely covers the magnetic core 22. The high magnetic permeability layer 42 covers at least part of the element region that the windings w₁˜w₆ (or the branches B₁˜B₃) are formed in top view of the inductive device 40. For example, the high magnetic permeability layer 42 may completely covers the element region in the transverse direction, while partially covering the element region in longitudinal direction to leave some area for arrangement of other electronic components. In some aspects, the high magnetic permeability layer 42 may completely cover the element region.

The high magnetic permeability layer 42 can effectively enhance the magnetic flux path, thereby increasing the inductance of the inductive device 40.

The high magnetic permeability layer 42 is, for example, a nanocrystalline tape, in which the equivalent thickness of the nanocrystalline material is, for example, 140 nanometers.

According to the aforementioned description, the high magnetic permeability layer 42 is formed on the top surface of the support member 21. Alternately, another high magnetic permeability layer 42 can be formed on the back surface of the support member 21 without contacting the magnetic core 22 and the windings w₁˜w₆ (or the branches B₁˜B₃), as shown in FIG. 42.

In summary, the (heterogeneous integrated) inductive device proposed in the present invention has at least the following features:
1. The magnetic core is embedded within the printed circuit board (PCB) or support member, thereby increasing the inductance and reducing power loss. Moreover, the magnetic core does not protrude from the surface of the PCB, thus avoiding the occupation of surface space.
2. The winding structures of the respective branches are arranged in an interleaved configuration, enabling balanced current distribution and reducing power loss.
3. The winding structures of the respective branches are arranged in a symmetrical configuration, also enabling balanced current distribution and reducing power loss.
4. The windings on different board layers within each branch are connected in series, which prevents the overall inductance from decreasing due to imperfect coupling between board layers of PCB when multiple windings are connected in parallel.

Another embodiment of the present invention discloses a power converter. The converter includes a switching module; and the aforementioned inductive device, coupled to the switching module.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An inductive device, comprising:
a support member;
a magnetic core arranged in the support member; and
a plurality of branches arranged in the support member and connected in parallel with each other;
wherein each of the plurality of branches has a winding structure wound around the magnetic core.

2. The inductive device as claimed in claim 1, wherein the support member includes a plurality of board layers, each of which is provided with a winding;
the winding structure of each branch is formed by a predetermined number of windings connected in series; and
the predetermined number of windings are disposed on different board layers.

3. The inductive device as claimed in claim 2, wherein the plurality of branches includes a first branch to an n-th branch, and among the first branch to the n-th branch, all the windings disposed on different branches are arranged in an interleaved manner.

4. The inductive device as claimed in claim 3, wherein n is at least 2, and the predetermined number is at least 2.

5. The inductive device as claimed in claim 2, wherein the plurality of branches includes a first branch to an n-th branch; and
at least a part of the windings forming the winding structures of the first to the n-th branches are arranged in a symmetrical manner.

6. The inductive device as claimed in claim 5, wherein each of the first branch to the n-th branch includes at least one winding and another winding connected in series; and
the symmetrical arrangement of windings includes a configuration from one winding of the first branch to one winding of the n-th branch, and from the one winding of the n-th branch to another winding of the first branch.

7. The inductive device as claimed in claim 3, wherein a product of the predetermined number and the number of branches is not greater than the number of board layers.

8. The inductive device as claimed in claim 5, wherein the product of the predetermined number multiplied by the number of branches is not greater than the number of board layers.

9. The inductive device as claimed in claim 7, wherein a surface layer of the support member covers the magnetic core.

10. The inductive device as claimed in claim 8, wherein the surface layer of the support member covers the magnetic core.

11. The inductive device as claimed in claim 2, wherein the support member is a multilayer printed circuit board.

12. The inductive device as claimed in claim 11, wherein each winding disposed on the respective board layer is made of a conductor.

13. The inductive device as claimed in claim 12, wherein the conductor is copper.

14. The inductive device as claimed in claim 1, wherein a portion of the magnetic core surrounded by the plurality of windings is a continuous integrated structure.

15. The inductive device as claimed in claim 1, wherein the magnetic core is embedded within the support member.

16. The inductive device as claimed in claim 1, further comprising a high magnetic permeability layer;
wherein the magnetic core and the branches are covered by the high magnetic permeability layer, and the magnetic permeability of the high magnetic permeability layer is more than three times that of the magnetic core.

17. The inductive device as claimed in claim 16, wherein the high magnetic permeability layer completely covers the magnetic core, and covers at least part of the branches.

18. The inductive device as claimed in claim 16, wherein the high magnetic permeability layer is provided on a surface of the support member, without contacting the magnetic core and the branches.

19. The inductive device as claimed in claim 18, wherein the support member is a multilayer printed circuit board.

20. A power converter, comprising:
a switching module; and
an inductive device, coupled to the switching module;
wherein the inductive device comprises:
a support member;
a magnetic core arranged in the support member; and
a plurality of branches arranged in the support member and connected in parallel with each other;
wherein each of the plurality of branches has a winding structure respectively wound around the magnetic core.
